(19) United States
(12) Patent Application Publication
(10) Pub. No.: US 2004/0091674 A1
(43) Pub. Date: May 13, 2004

(54) Mat with elastic compressible elements

(75) Inventor: Gordon L. Altshuler, Sunfish Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company, St. Paul, MN

(21) Appl. No.: 10/291,998

(22) Filed: Nov. 12, 2002

(51) Int. Cl. B32B 1/00

(52) U.S. Cl. 428/174

(57) ABSTRACT

Mats for use on, e.g., floors that combine the desirable compression and resilience associated with anti-fatigue mats are disclosed. The mats provide a combination of compression and resilience while also typically exhibiting a resistance to movement or shifting due to the application of uneven loads such as those applied by individuals walking on the mats. The mats include a plurality of elastic compressible elements attached to each other by separate land portions or by a continuous base sheet. The elements may be hollow tubular structures that include an open slot having a slot width that has a dimension relative to the element width. In embodiments including a continuous base sheet, the elements may have a contact width with the base sheet that is narrower than the element width.

### BACKGROUND

The use of mats on surfaces such as floors, walkways, etc. can serve a number of purposes such as protection, fluid management, cushioning, sound-deadening, defining a path or direction, etc. In many instances, mats may be used on floors to reduce fatigue for individuals required to stand or walk on the surface in question over long periods of time. Such mats may commonly be referred to as anti-fatigue mats.

Among the properties of anti-fatigue mats, one common property is typically compression and resilience of the materials in the mat. In other words, the mats tend to compress under load, and that compression may result in, e.g., subtle movements in individuals—even while standing still. It is theorized by many that those subtle movements may increase circulation and prevent stiffening of muscles and ligaments, etc. The mats are preferably resilient such that they provide compressibility over many loading cycles.

The compression and resilience associated with the floor mats can, however, result in a significant disadvantage in that the mats may tend to move relative to the surface on which they are located. In some instances, the mats may be described as “walking” over the floor or other surface on which they are located. That tendency to shift is the result of compression and expansion in different locations on the mat as when, e.g., an individual walks on the mat.

Various approaches to combat movement of the mats include securing the mats using clips, adhesives, retaining strips, structures on the bottom of the mat (e.g., the portion facing the surface on which the mat is located), etc. These approaches, however, often make installation and/or removal of the mats more complex and, therefore, costly.

### SUMMARY OF THE INVENTION

The present invention provides mats for use on, e.g., floors that combine the desirable compression and resilience associated with anti-fatigue mats. The mats of the present invention provide that desired combination of compression and resilience while also typically exhibiting a surprising resistance to movement or shifting due to the application of uneven loads such as those applied by individuals walking on the mats.

In different embodiments, the mats include a plurality of elastic compressible elements attached to each other by separate land portions or by a continuous base sheet. The elements may be hollow tubular structures that include an open slot having a slot width that has a dimension relative to the element width such that the mat as a whole exhibits surprising resistance to movement or shifting during use. In other embodiments including a continuous base sheet, the elements may have a contact width with the base sheet that is narrower than the element width such that the mat as a whole exhibits surprising resistance to movement or shifting during use.

In various aspects, the mats of the present invention may also be provided with coatings or other components that may provide desired properties such as anti-skid tendencies, luminescence, reflectivity, etc. as discussed more completely below. The mats may also be provided with drainage openings to allow fluids and/or particulates to pass through the mats.

It may be particularly preferred that the mats of the present invention be designed such that they can be manufactured in a continuous profile extrusion process. Extruded mats may provide advantages in terms of reduced manufacturing costs, uniform shape and size of the elements of the mats, etc. Furthermore, extrusion may provide the ability to construct different portions of the mats with different materials that may possess desired, but different, properties such as compressibility, tackiness, etc.

In some instances, the mats of the present invention may be amenable to the addition and retention of sheet materials positioned over the mats to provide properties such as absorbency, impermeability, permeability, aesthetics, electrical conductivity, etc.

In one aspect, the present invention provides a mat with a pair of opposing mat edges and a plurality of elastic compressible elements distributed between the opposing mat edges and aligned with a first direction, wherein adjacent elastic compressible elements are connected to each other by a land portion proximate a first major surface of the mat. Each of the elastic compressible elements includes an element length measured along the first direction and an element width measured transverse to the element length; and a hollow tubular structure having an open slot formed along the element length, wherein the open slot opens towards the first major surface of the mat and has a slot width that is less than the element width.

In another aspect, the present invention provides a floor mat having a pair of opposing mat edges and a plurality of elastic compressible elements distributed between the opposing mat edges and aligned with a first direction, wherein adjacent elastic compressible elements are connected to each other by a land portion proximate a first major surface of the floor mat. Each of the elastic compressible elements has an element length measured along the first direction and an element width measured transverse to the element length, wherein the element length of each elastic compressible element of the plurality of elastic compressible elements is substantially coextensive with the floor mat in the first direction. Each of the elastic compressible elements further has a hollow tubular structure with an open slot formed along the element length, wherein the open slot opens towards the first major surface of the floor mat and has a slot width that is 75% or less of the element width.

In another aspect, the present invention provides a mat with a pair of opposing mat edges extending along a first direction. The mat also includes a base sheet with first and second major surfaces and a plurality of elastic compressible elements distributed over and attached to the first major surface of the base sheet, the plurality of elastic compressible elements distributed between the opposing mat edges and aligned with the first direction. Each of the elastic compressible elements has an element length measured along the first direction and an element width measured transverse to the element length; and a contact width between the elastic compressible element and the first major surface of the base sheet, wherein the contact width is less than the element width.

These and other features and advantages may be described below in connection with various illustrative embodiments of the invention.

### BRIEF DESCRIPTION OF THE DRAWINGS

FIG. 1 is a perspective view of one embodiment of a mat according to the present invention.

FIG. 2 is a plan view of the major surface of the mat of FIG. 1 including the elastic compressible elements.

FIG. 3 is a plan view of the first major surface of the mat of FIG. 1, that is, the surface opposite that depicted in FIG. 2.

FIG. 4 is an enlarged end view of one elastic compressible element in the mat of FIG. 1.

FIGS. 5A & 5B are end views of portions of alternative mats according to the present invention.

FIG. 6 is a plan view of a mat according to the present invention including drainage openings formed therein.

FIG. 7 is an end view of two mats of the present invention that interlock along adjacent edges.

FIG. 8 is an end view of a mat according to the present invention including a sheet element located over the tubular elements, the sheet element retained by a retaining element.

FIGS. 9A & 9B are end views of a mat according to the present invention including a sheet element located over the tubular elements, the sheet element retained by interlocking tubular elements.

FIG. 10 is a plan view of two mats of the present invention connected together at the ends of the elements located on each mat.

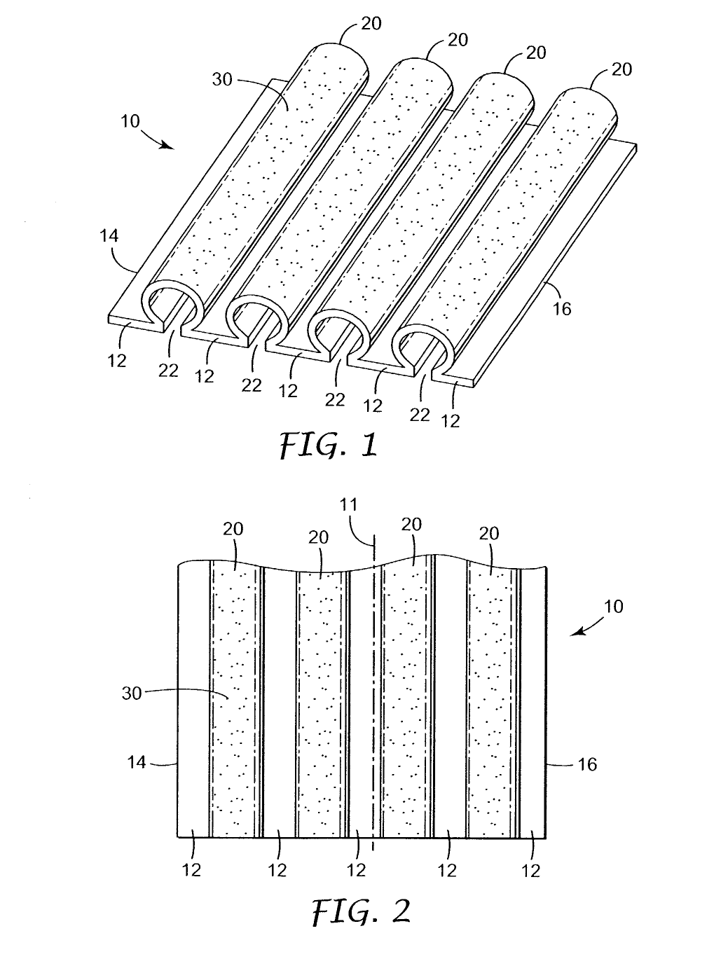

FIG. 1I is a cross-sectional view of a portion of a mat according to the present invention including a beveled edge piece.

FIG. 12 is an end view of an alternative mat according to the present invention.

FIG. 13 is an end view of an alternative mat according to the present invention.

FIG. 14 is an end view of an alternative mat according to the present invention.

FIG. 15 is an enlarged end view of one solid elastic compressible element in the mat of FIG. 14.

### DETAILED DESCRIPTION OF ILLUSTRATIVE EMBODIMENTS OF THE INVENTION

The present invention provides mats and methods of manufacturing them. The mats may be particularly well-suited for use on floors and other walkways, but it should be understood that the mats may be used on any surface, horizontal, vertical, or otherwise. In other words, unless explicitly limited to floormats, the present invention should not be limited to articles used on floors.

One embodiment of a mat according to the present invention is depicted in FIGS. 1-3. The mat 10 includes elongated elastic compressible elements 20 distributed between the mat edges 14 and 16. The mat 10 includes a land 12 located between adjacent elements 20, wherein the adjacent elements 20 are connected to each other by the land 12 located between the adjacent elements 20.

The elastic compressible elements 20 are aligned on the mat 10 along a first direction that is defined in FIG. 2 by axis 11. It may be preferred that the elements 20 be arrayed across the width of the mat 10 in a parallel arrangement, although perfect parallelism is not required. As referred to herein, “width” is the direction transverse to the first direction as defined by axis 11. Furthermore, it may be preferred that the elements 20 have a length that is substantially coextensive with the mat 10 in the first direction defined by axis 11, although in some instances one or more of the elements 20 may not be coextensive with the mat 10 in the first direction as defined by axis 11.

Each of the elastic compressible elements 20 is preferably a structure that elastically deforms in response to a load. For example, it may be preferred that the elements 20 compress or flex to some degree such that the overall thickness of the mat decreases in response to the weight of a person standing on the elastic compressible elements 20. As used herein, “elastic compressible element” means an element that undergoes compression in response to a load and, further, that the element substantially recovers its pre-loading shape within a period of about one minute or less when the load is removed. It may be preferred that the load used in the foregoing description be determined based on the weight of a person standing on the mat.

Each of the elastic compressible elements 20 in the mat depicted in FIGS. 1-3 is a hollow tubular structure that includes an open slot 22 extending along the length of the tubular element 20 and opening towards the first major surface of the mat 10 as seen in FIGS. 1 & 3. It may be preferred that the open slot 22 extend along substantially the entire length of the tubular element 20 in which it is located, although in some instances, the slot 22 may be closed at one or more discrete locations along the length of the tubular element 20. It may be preferred, however, that the slot 22 be open along substantially all of the length of the tubular element 20 (e.g., 95% or more).

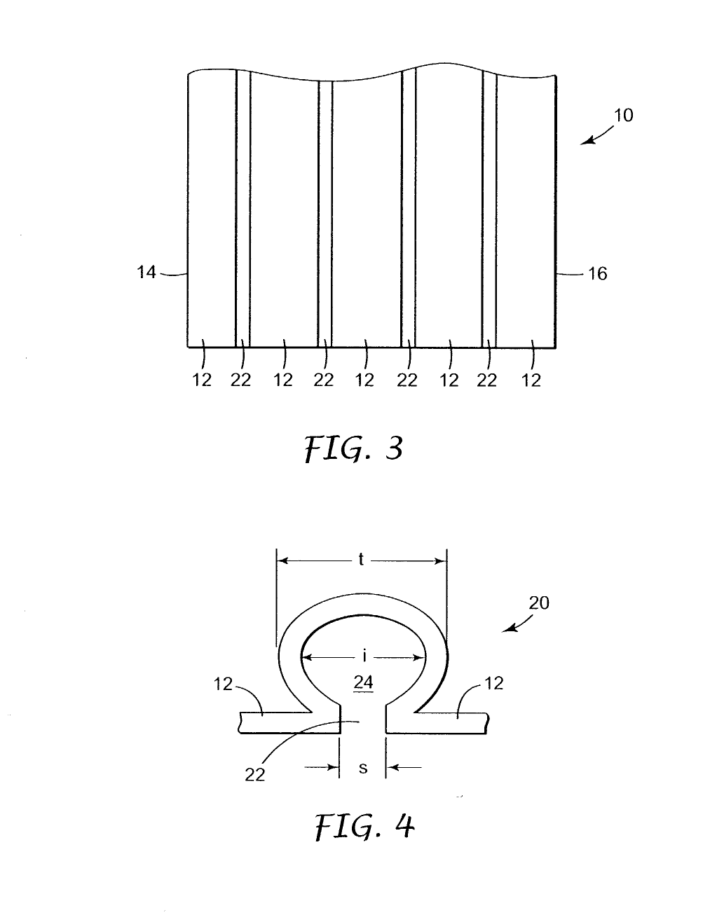

Although the width of the slots 22 depicted in, e.g., FIG. 3, is relatively constant, it should be understood that slot width may, in some instances vary over the length of the elements 20 within the bounds discussed herein.

With reference to FIG. 4, which is an enlarged end view of one of the tubular elements 20, the slot 22 can be characterized as having a slot width (s) and the tubular element 20 has an element width (t) that corresponds to the maximum width of the exterior of the tubular element 20. It is preferred that the slot width (s) be less than the element width (I). In addition to the above relationship, it may be preferred that the interior width (i) of the tubular element 20, that is, the maximum width within the interior volume 24 of the tubular element 20, be greater than the slot width (s). In some instances, the relationship between slot width (s) and the element width (t) may preferably be such that the slot width (s) is 75% or less of the element width (t), possibly 50% or less of the element width (t), and even 25% or less of the element width (t).

Although not wishing to be bound by theory, it appears that when the slot width (s) is less than the element width (t) and/or the interior width (i), compression of the tubular element 20 does not cause substantial changes in the slot width that would, when the compressive force is removed, result in movement or “walking” of the mat 10 over the surface on which the mat is located.

As discussed above, it should be understood that widths of the various features of the elastic compressive tubular elements of the present invention are measured transverse to the element length.

An optional feature of mats according to the present invention also seen in, e.g., FIG. 1, is that the tubular elements 20 may include particles 30 that may provide a variety of different properties to the mat 10. For example, particles 30 may enhance the frictional properties of the mat 10 to improve its anti-skid characteristics. The particles 30 may be, e.g., granular and/or fibrous in nature. Other properties that may be provided by particles located on mats of the present invention may be, e.g., luminescence, reflectivity, retroreflectivity, absorbance, etc.

In addition to, or in place of, particles 30, the tubular elements 20 and/or land 12 may be provided with one or more coatings that may also affect various characteristics of the mat 10. For example, coatings may be used to provide a desired level of friction, electrical conductivity (e.g., for antistatic characteristics), luminescence, reflectivity, absorbance, etc. The coatings may be selected to, e.g., enhance properties such as friction in the absence of one or more contaminants such as oil, grease, water, etc. Furthermore, the mats of the invention may be provided with graphic images by printing or other techniques.

With respect to frictional characteristics in particular, it may also be desirable to provide the lands 12 on the bottom of the mat 10 (where the bottom is defined relative to FIGS. 1-3 as the side of the mat 10 opposite the tubular elements 20) with a coating or structure (e.g., particles) that improves the frictional characteristics of the mat 10 as a whole. Such a coating or structure may be selected based on the properties of the floor or other surface on which the mat 10 is to be located, on contaminants that may be expected to be present (e.g., oil, grease, water, etc.), or on any other suitable consideration. Increasing the coefficient of friction of the lands 12 may help to limit unintended movement of the mat 10 during use.

The frictional properties of the mat 10 may also be enhanced by providing a structure on the uppermost surfaces of the tubular elements 20 and/or on the lands 12. The structure may take the form of, e.g., ribs, ridges, etc. For example, a group of ribs, ridges, etc. could be provided on some or all of the tubular elements 20. In another alternative, a group of ribs, ridges, etc. could be provided on some or all of the lands 12. These structures may be provided in place of, or in addition to either or both of the particles 30 and coatings discussed above.

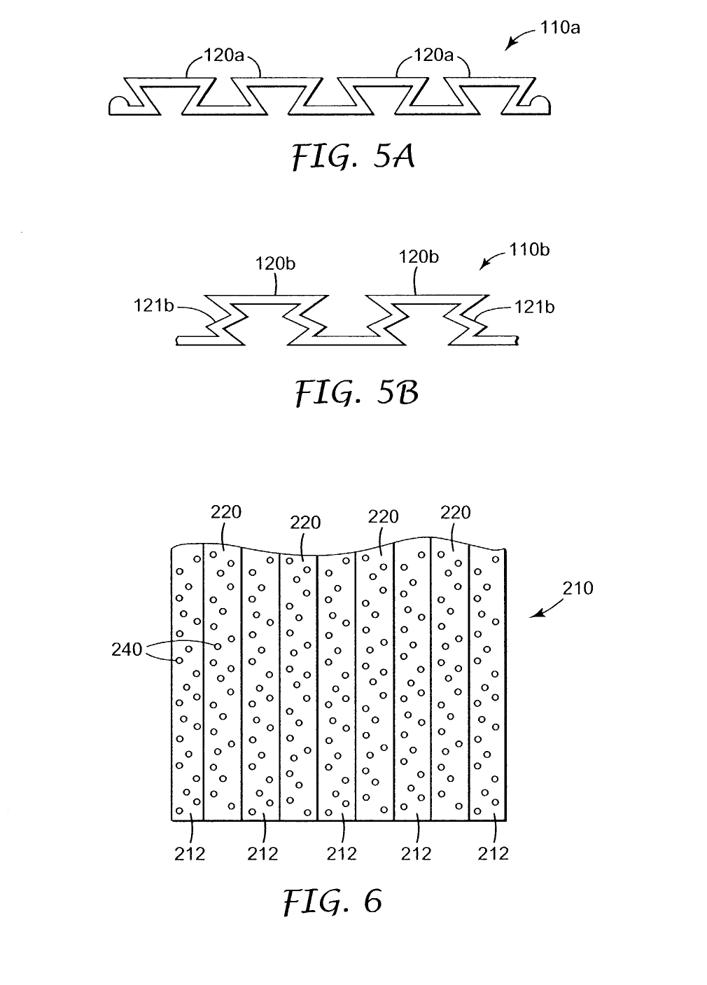

The elastic compressible elements 20 of FIGS. 1-4 have a generally rounded or arcuate profile or shape when viewed along their length. Mats according to the present invention may, however, include tubular elements 20 that have any suitable profile given the width relationships described herein. Examples of a alternative profiles for the elements on a mat according to the present invention are depicted in FIGS. 5A & 5B. The mat 110a of FIG. 5A includes elements 120a that are formed of essentially linear sections such that the upper surface (as seen in FIG. 5) of the mat 110a as a whole is relatively flat. The mat 110b of FIG. 5B includes elements 120b that include multiple legs 121b as opposed to the simpler structures seen in FIG. 5A.

Another optional feature of mats according to the present invention is depicted in FIG. 6 where the mat 210 includes elements 220 connected by land portions 212. In the mat 210, both the land portions 212 and the elements 220 include drainage openings 240 formed therein such that liquids and/or particulate matter can pass through the mat 210. Although the drainage openings 240 are depicted in both the land portions 212 and the elements 220, it should be understood that the drainage openings 240 may be located in only the land portions 212 or only the elements 220. The drainage openings 240 may be uniformly dispersed over the mat 210, or they may be located only in selected areas. In addition, the drainage openings 240 may be arranged randomly or in a selected pattern. The drainage openings 240 may be formed by any suitable technique, e.g., punching, drilling, etc.

In addition to providing for drainage of liquids and/or particulates, the drainage openings may also increase the anti-skid and/or frictional characteristics of the mats. The drainage openings 240 may do so by virtue of interactions between the edges of the openings and the other surface that comes into contact with those edges.

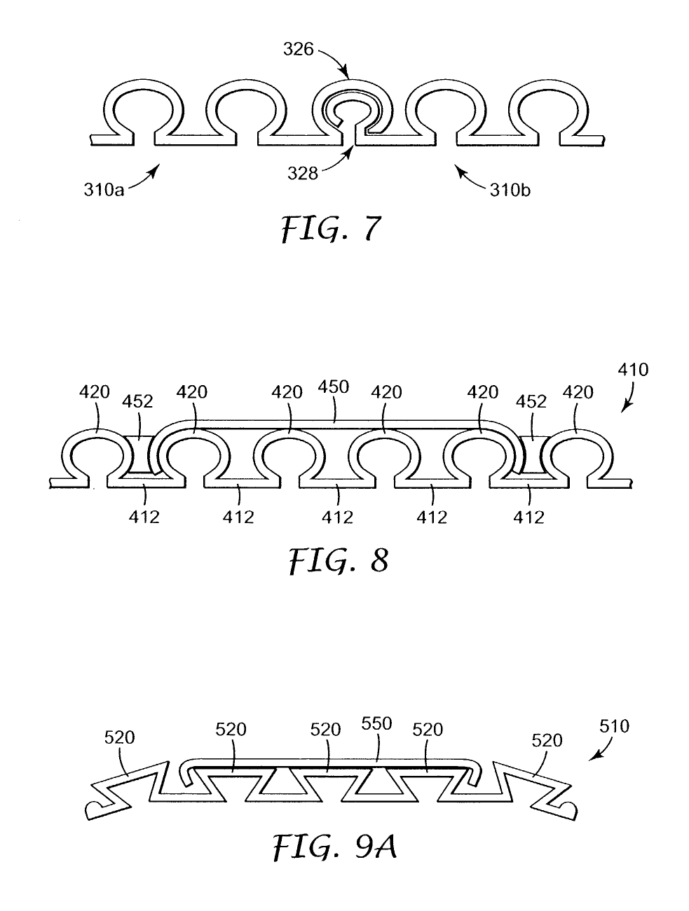

FIG. 7 depicts another optional feature of mats according to the present invention. The mat 310a on the left side of FIG. 7 includes a partial tubular element 326 located along one outside edge of the mat 310a. The adjacent mat 310b includes a complementary mating element 328 located along an outside edge that is designed to fit within and be retained by the partial tubular element 326. As a result of the mating tubular structures provided by tubular element 326 and mating element 328, adjacent mats 310a and 310b are retained in close proximity to each other. Although element 328 is depicted as tubular, it may alternatively be solid.

Any variety of structures may be used to connect mats of the present invention together. One potential advantage of the structures depicted in FIG. 7 is, however, that the appearance of the connected mats 310a and 310b is essentially the same as if one continuous mat were provided.

Another potential advantage of the structures depicted in FIG. 7 is that the tubular element 326 may be stiffened by the mating element 328 located therein. It will be understood that any of the tubular elements of the mats according to the present invention may be stiffened by the addition of a stiffener located within the interior of the tubular elements. For example, it may be desirable to provide one or more stiffeners in different locations over the width of the mats. The stiffeners may, for example, take the form of metallic rods that, in addition to stiffening the mat, may also enhance its resistance to movement by adding mass to the mat.

Another optional feature of the mats of the present invention is depicted in FIG. 8 where a fabric, film or other sheet element 450 is located over the tubular elements 420 of the mat 410. Like the other mats described herein, tubular elements 420 are connected by land portions 412. The sheet element 450 may be of any desired construction, e.g., polymeric film, woven fabric, nonwoven fabric, monolayer sheet, multilayer laminate, etc. The sheet element 450 may possess a variety of characteristics such as absorbency, permeability, impermeability, elasticity, tackiness, electrical conductivity, luminescence, etc. The sheet element 450 may also provide a vehicle for a graphic image that may be printed or otherwise provided on the sheet element 450.

Although the sheet element 450 may simply be laid over the mat 410 or its edges simply tucked in between adjacent tubular elements 420 on the mat 410, it may be preferred that the sheet element 450 be more securely retained in place on the mat 410. One structure for retaining a sheet element 450 in place on a mat of the present invention is depicted in FIG. 8 and includes retaining elements 452 that are located between adjacent tubular elements 420 on the mat 410. The retaining elements 452 fit within the space between adjacent tubular elements such that the sheet element 450 is retained by friction. The retaining element 452, tubular elements 420 and/or land portion 412 located proximate the retaining element 452 may be coated with an adhesive or other friction-enhancing substance to improve retention of the sheet element 450. Alternatively, the retaining element 452 may include structures (e.g., hooks from hook and loop fasteners, teeth, knurling, etc.) that assist with retention of the sheet element 450.

Furthermore, although the retaining elements 452 are depicted proximate the sides of the mat 410, one or more retaining elements 452 could be provided in intermediate locations across the width of the mat 410.

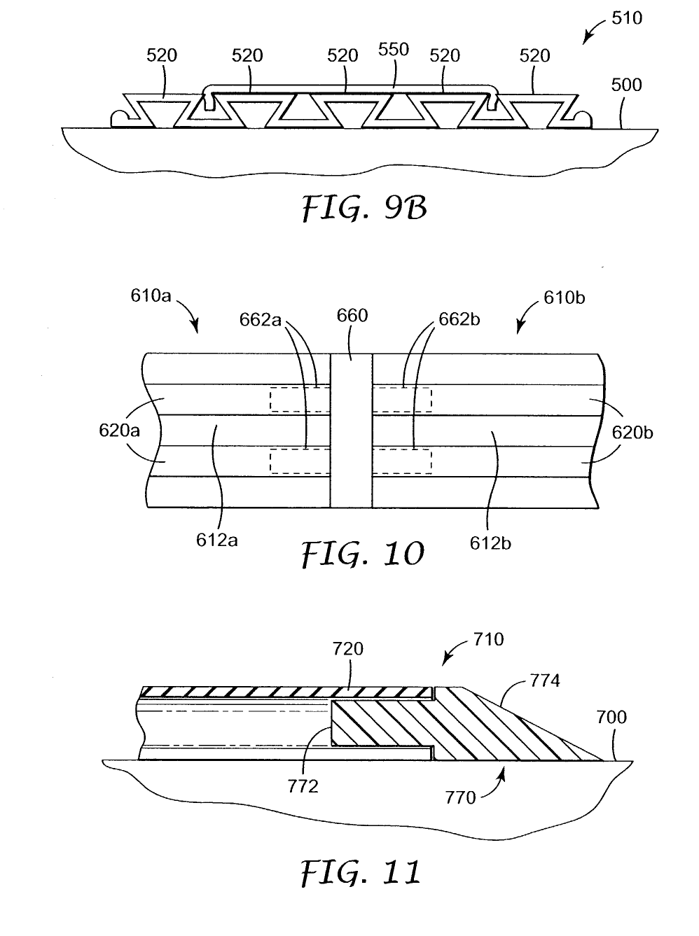

FIGS. 9A & 9B depict an alternative structure for more securely retaining a sheet element 550 on a mat 510 including tubular elements 520 located thereon. The sheet 550 is retained between a pair of interfering tubular elements 520 located at, e.g., the edges of the mat 510. In FIG. 9A, the tubular elements 520 are depicted in their normal, unbiased positions, such that a gap exists between the pairs of adjacent, interfering tubular elements 520 at the outer edges of the mat 510. The sheet element 550 can be located within that gap as seen in FIG. 9A.

When the mat is located on a surface 500 as seen in FIG. 9B, however, the outer pairs of interfering tubular elements 520 are rotated such that the gap disappears, thereby retaining the sheet element 550 between the interfering tubular elements 520. The retention forces may be generated by friction. In some instances, all or a portion of the tubular elements 520 may be coated with an adhesive or other friction-enhancing substance to improve retention of the sheet element 550. Alternatively, one or both of the interfering tubular elements 520 may include structures (e.g., teeth, knurling, etc.) that assist with retention of the sheet element 550.

Although all of the tubular elements 520 are depicted as having a similar shape, it will be understood that the interfering tubular elements may have different shapes, provided they complement each other in a manner that results in retention of the sheet element 550. Furthermore, although the interfering tubular elements 520 are depicted proximate the sides of the mat 510, one or more pairs of interfering tubular elements could be provided in intermediate locations across the width of the mat 510.

The mats depicted and described in connection with FIGS. 1-9 may all preferably be manufactured in a continuous profile extrusion process. In that process a web is extruded through a die having an opening that is cut, for example, by electron discharge machining. The shape of the die is designed to generate a web with a desired cross-sectional shape or profile. The entire mat, its land portions and elastic compressible elements, may be manufactured of the same material. Alternatively, the extrusion process can be used to provide various portions of the mats in different materials that may possess different properties. For example, the elastic compressible elements may be manufactured with one composition and the land portions manufactured with a different composition. Such extrusion methods will be well known to those of skill in the art of extrusion and will not be further described herein. Profile extrusion is strongly preferred; however, instead of extruding, mats of the invention can be prepared in other ways, for example, by injection molding, compression molding, corrugation or vacuum forming.

Mats according to the present invention may be made from a variety of materials but most commonly are made from polymeric materials, using generally any polymer that can be melt processed. Thermoset and reactive polymers may also be used. Homopolymers, copolymers and blends of polymers are useful, and may contain a variety of additives. Inorganic materials such as metals may also be used. The materials are chosen to provide the desired elastic compressible characteristics described above.

Examples of some materials that may be used to manufacture mats according to the present invention are materials that are themselves compressible such as thermoplastic elastomers. Elastomers include, for example, natural or synthetic rubber, styrene block copolymers containing isoprene, butadiene, or ethylene (butylene) blocks, metallocene-catalyzed polyolefins, polyurethanes, polydiorganosiloxanes, etc. In other instances, materials that may not themselves be considered compressible may be used to manufacture mats with elastic compressible structures that are compressible. Examples of such materials include, but are not limited to, for example, polyolefins such as polypropylene or polyethylene, polystyrene, polycarbonate, polymethyl methacrylate, ethylene vinyl acetate copolymers, acrylate-modified ethylene vinyl acetate polymers, ethylene acrylic acid copolymers, nylon, polyvinylchloride, and engineering polymers such as polyketones or polymethylpentanes, etc. Mixtures of these materials and/or elastomers may also be used

Suitable additives include, for example, plasticizers, tackifiers, fillers, colorants, ultraviolet light stabilizers, antioxidants, processing aids (urethanes, silicones, fluoropolymers, etc.), conductive fillers to give the mat a level of conductivity, pigments, foaming agents and combinations thereof.

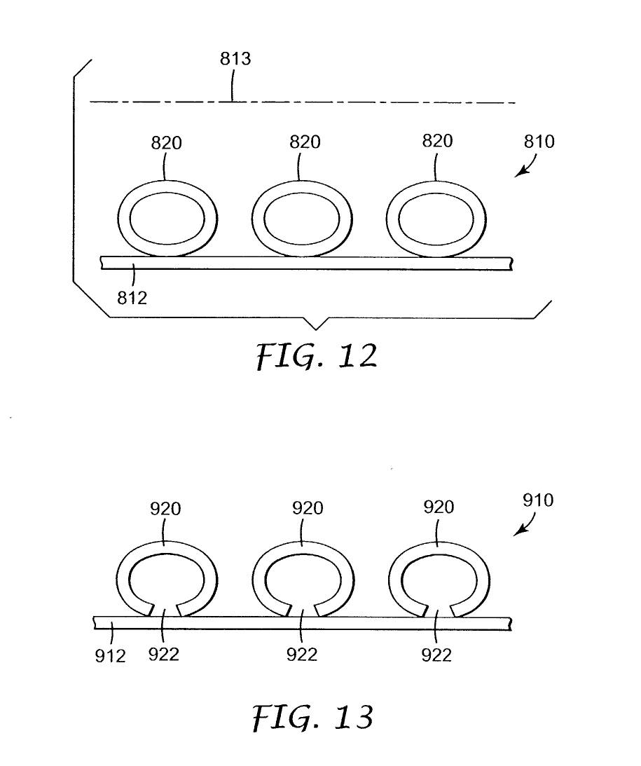

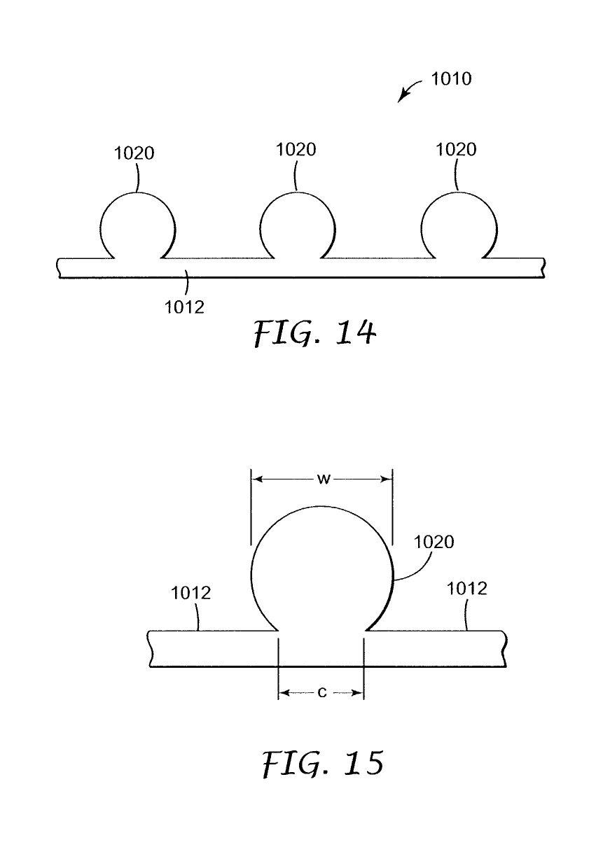

FIG. 10 is a plan view of two mats 610a and 610b (collectively referred to as “mats 610”) that are connected to each other along the ends at which the elastic compressible elements 620a and 620b on mats 610a and 610b terminate. Such a connection may be referred to as a “butt-end connection” between the mats 610. The connector 660 includes plugs 662a (depicted in broken lines) that are inserted into the elements 620a of mat 610a. Similarly, the connector 660 also includes plugs 662b that are inserted into the elements 620b of mat 610b. The plugs 662a and 662b may be retained within their respective elements 620a and 620b by, e.g., friction, adhesives, structures (such as serrations, teeth, etc.), or any other suitable technique or structure.

In variations on the connector 660 depicted in FIG. 10, it will be understood that the plugs 662a and 662b may be located between adjacent pairs of tubular elements 620a and 620b rather than within the tubular elements. In another alternative, a plurality of separate plugs may be supplied (in the absence of a common connector structure) such that each plug can be inserted separately into the mats 610.

FIG. 1I is a cross-sectional view of a portion of another mat 710 that includes another optional feature that may be provided with a mat according to the present invention. The option feature depicted in FIG. 11 is a transition piece 770 used to provide a smooth transition from the mat 710 to a surface 700 on which the mat 710 is located. The transition piece 770 may include plugs 772 that can be inserted into the elements 720 of mat 710 (similar to the plugs used to connect mats 610 as discussed above). The depicted transition piece also includes a beveled or sloped transition surface 774 that extends from the top of the mat 710 down to the surface 700. Although not depicted, it will be understood that a transition piece may also be provided for the edges of the mats according to the present invention. For example, a transition piece with a beveled or sloped transition surface may be provided in combination with mating structures such as depicted in FIG. 7.

FIG. 12 depicts another alternative mat 810 that may be provided in connection with the present invention. The mat 810 includes tubular elements 820 arrayed over a base sheet 812. Unlike the constructions depicted in FIGS. 1-9, the mat 810 does not include slots in the tubular elements 820 that open onto the bottom surface of the mat 810 (where the bottom is the side opposite the side on which the tubular elements are located). In some instances, the base sheet 812 may be substantially inextensible in at least the direction of axis 813 (transverse to the length of the elements 820) such that compression of the tubular elements 820 does not result in significant stretching of the underlying base sheet 812 along the axis 813 as loads are placed on the mat 810. In addition, the base sheet 812 may consist of a solid sheet, fabric, foam, or open mesh structure, and the like.

Although mat 810 may also be manufactured by extrusion or molding processes, the tubular elements 820 may, instead, be provided separately from the base sheet 812 and attached thereto by any suitable technique (e.g., adhesively, thermal welding, chemical welding, ultrasonic welding, etc.).

Although the elastic compressible elements 820 of the mat 810 are depicted as closed hollow tubular structures, FIG. 13 depicts a variation in which the elastic compressible elements 920 of mat 910 include openings 922 while the base sheet 912 extends continuously underneath the tubular elements 920 (with the exception of, e.g., drainage openings if provided in the base sheet 912). Like mat 810, the base sheet 912 may be inextensible in all directions or in the direction transverse to the direction along which elements 920 are aligned.

FIG. 14 depicts yet another embodiment of a mat 1010 manufactured according to the present invention. The mat 1010 includes elastic compressible elements 1020 attached to a base sheet 1012. One difference with the elements 1020 of mat 1010 and those discussed above is that the elements 1020 are solid structures, i.e., they are not hollow tubular structures. As discussed with respect to mat 810, the elements 1020 may be manufactured separately and attached to the base sheet 1012 or they may be manufactured with the base sheet 1012 by, e.g., extrusion. It should be noted that mats that include a combination of solid elastic compressible elements and hollow elastic compressible elements are also within the scope of the present invention.

With reference to FIG. 15, which is an enlarged end view of one of the elements 1020, the element 1020 can be characterized as having a contact width (c) that is the width of the contact area between the element 1020 and the base sheet 1012. The element 1020 has an element width (w) that corresponds to the maximum width of the exterior of the element 1020. It may be preferred that the contact width (c) be less than the element width (w). In some instances, the relationship between contact width (c) and the element width (w) may preferably be such that the contact width (c) is 75% or less of the element width (w), possibly 50% or less of the element width (w), and even 25% or less of the element width (w).

Although not wishing to be bound by theory, it appears that when the contact width (c) is less than the element width (w), compression of a solid elastic compressible element 1020 does not cause substantial elongation in the base sheet 1012 that would, when the compressive force is removed, result in movement or “walking” of the mat 1010 over the surface on which the mat is located.

As discussed above, it should be understood that widths of the various features of the elastic compressible elements of the present invention are measured transverse to the element length.

The elastic compressible elements of the mats depicted in FIGS. 12-14 have a generally rounded or arcuate profile or shape when viewed along their length. As described above, the mats of the present invention may, however, include compressible elements that have any suitable profile given the width relationships described within. As also described above, the compressible elements may be arrayed across the width of the mat in a parallel arrangement, although perfect parallelism is not required. Furthermore, it may be preferred that the compressible elements have a length that is substantially coextensive with the length of the mat, although in some instances one or more of the compressible elements may not be coextensive with the length of the mat. Additionally, the mats depicted in FIGS. 12-14 may possess any of the variations described above, e.g., particulates, coatings, structures (such as ribs, ridges, etc.), drainage openings, interlocking structures, mating structures, etc. to provide any desired characteristic. The mats may also be used with a sheet element as described above if so desired.

The preceding specific embodiments are illustrative of the practice of the invention. This invention may be suitably practiced in the absence of any element or item not specifically described in this document.

Various modifications and alterations of this invention will become apparent to those skilled in the art without departing from the scope of this invention, and it should be understood that this invention is not to be unduly limited to illustrative embodiments set forth herein, but is to be controlled by the limitations set forth in the claims and any equivalents to those limitations.

1. A mat comprising a pair of opposing mat edges, the mat further comprising a plurality of elastic compressible elements distributed between the opposing mat edges and aligned with a first direction, wherein adjacent elastic compressible elements are connected to each other by a land portion proximate a first major surface of the mat, wherein each of the elastic compressible elements comprises:
an element length measured along the first direction and an element width measured transverse to the element length;
a hollow tubular structure comprising an open slot formed along the element length, wherein the open slot opens towards the first major surface of the mat and comprises a slot width that is less than the element width.

2. A mat according to claim 1, wherein the element length of each elastic compressible element of the plurality of elastic compressible elements is substantially coextensive with the mat in the first direction.

3. A mat according to claim 1, wherein the slot width is 75% or less of the element width.

4. A mat according to claim 1, wherein the slot width is 50% or less of the element width.

5. A mat according to claim 1, wherein the slot width is 25% or less of the element width.

6. A mat according to claim 1, wherein the land portion connecting adjacent elastic compressible elements comprises a plurality of drainage openings formed therein.

7. A mat according to claim 1, wherein each elastic compressible element of the plurality of elastic compressible elements comprises a plurality of drainage openings formed therein.

8. A mat according to claim 1, further comprising mating structures on the opposing mat edges, wherein the mating structures extend along the first direction.

9. A mat according to claim 1, further comprising a sheet element covering the plurality of elastic compressible elements, wherein the sheet element is retained on the mat.

10. A mat according to claim 9, wherein the plurality of elastic compressible elements comprise a pair of interfering elements to retain the sheet element.

11. A mat according to claim 9, wherein a retaining element is located between a pair of adjacent elastic compressible elements of the plurality of elastic compressible elements, and wherein the sheet element is retained between the pairs of adjacent elastic compressible elements by the retaining element.

12. A mat according to claim 1, further comprising anti-skid particles located on the plurality of elastic compressible elements.

13. A mat according to claim 1, further comprising an anti-slip agent located on the bottom of the mat.

14. A floor mat comprising a pair of opposing mat edges and a plurality of elastic compressible elements distributed between the opposing mat edges and aligned with a first direction, wherein adjacent elastic compressible elements are connected to each other by a land portion proximate a first major surface of the floor mat, wherein each of the elastic compressible elements comprises:
an element length measured along the first direction and an element width measured transverse to the element length, wherein the element length of each elastic compressible element of the plurality of elastic compressible elements is substantially coextensive with the floor mat in the first direction;
a hollow tubular structure comprising an open slot formed along the element length, wherein the open slot opens towards the first major surface of the floor mat and comprises a slot width that is 75% or less of the element width.

15. A mat comprising a pair of opposing mat edges extending along a first direction, the mat comprising:
a base sheet comprising first and second major surfaces;
a plurality of elastic compressible elements distributed over and attached to the first major surface of the base sheet, the plurality of elastic compressible elements distributed between the opposing mat edges and aligned with the first direction, wherein each of the elastic compressible elements comprises:
an element length measured along the first direction and an element width measured transverse to the element length; and
a contact width between the elastic compressible element and the first major surface of the base sheet, wherein the contact width is less than the element width.

16. A mat according to claim 15, wherein the base sheet is inextensible in a direction transverse to the first direction.

17. A mat according to claim 15, wherein each elastic compressible element of the plurality of elastic compressible elements comprises an element length that is substantially coextensive with the mat in the first direction.

18. A mat according to claim 15, wherein the contact width is 75% or less of the element width.

19. A mat according to claim 1, wherein the contact width is 50% or less of the element width.

20. A mat according to claim 1, wherein the contact width is 25% or less of the element width.

21. A mat according to claim 15, wherein each elastic compressible element of the plurality of elastic compressible elements comprises a hollow tubular structure.

22. A mat according to claim 15, wherein each elastic compressible element of the plurality of elastic compressible elements comprises a solid structure.

23. A mat according to claim 15, wherein the base sheet comprises a plurality of drainage openings formed therein.

24. A mat according to claim 15, wherein each elastic compressible element of the plurality of elastic compressible elements comprises a plurality of drainage openings formed therein.

25. A mat according to claim 15, further comprising mating structures on the opposing mat sides, wherein the mating structures extend along the mat length.

26. A mat according to claim 15, further comprising a sheet element covering the plurality of elastic compressible elements, wherein the sheet element is retained on the mat.

27. A mat according to claim 26, wherein the plurality of elastic compressible elements comprise a pair of interfering elastic compressible elements, wherein the interfering elastic compressible elements retain the sheet element.

28. A mat according to claim 26, wherein a retaining element is located between a pair of adjacent elastic compressible elements of the plurality of elastic compressible elements, and wherein the sheet element is retained between the pairs of adjacent elastic compressible elements by the retaining element.

29. A mat according to claim 15, further comprising anti-skid particles located on the plurality of elastic compressible elements.

30. A mat according to claim 15, further comprising an anti-slip agent located on the second major surface of the base sheet.
